(19) United States
(12) Patent Application Publication
(10) Pub. No.: US 2009/0268172 A1
(43) Pub. Date: Oct. 29, 2009

(54) PROJECTOR WITH AUTOFOCUS DEVICE

(75) Inventor: CHAU-YUAN KE, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/270,619

(22) Filed: Nov. 13, 2008

(30) Foreign Application Priority Data
Apr. 28, 2008 (CN) 200810301323.9

(51) Int. Cl. G02B 7/09

(52) U.S. Cl. 353/101

(57) ABSTRACT

A projector include focus controlling device s a projection lens, an image capture device, an image analyzing device and a focus controlling device. The projection lens is configured for projecting an image onto a projection surface. The image capture device is configured for capturing images of the image projected on the projection surface. The image analyzing device is configured for analyzing intensity difference between adjacent pixels of the images captured by the image capture device and generating a control signal associated therewith. The focus controlling device is configured for focusing the projection lens at a position where there is maximum intensity difference between adjacent pixels in response to the control signal from the image analyzing device.

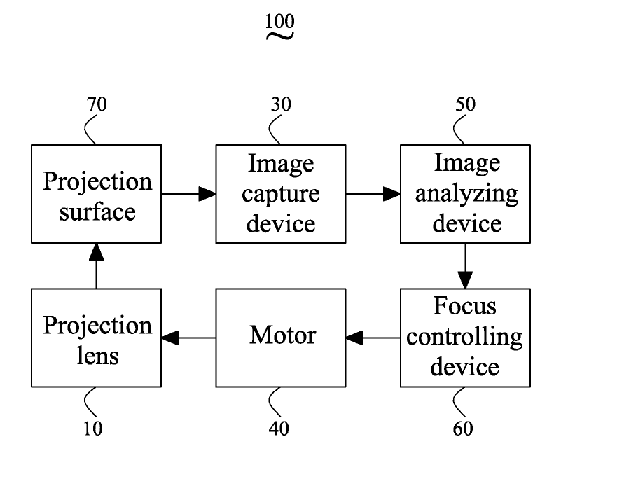

### BACKGROUND

1. Technical Field

The invention generally relates to optical projection, and more specifically, to a projector with an autofocus function.

2. Description of Related Art

During setup, a projector must be positioned such that a lens projects a focused image on a screen. After the focus is adjusted, the projector main body is moved toward or away from the screen to adjust the size or resolution of the projected image, after which the focus must be readjusted. This is time consuming and inconvenient.

What is needed, therefore, is an improved projector with an autofocus function.

### BRIEF DESCRIPTION OF THE DRAWING

The FIGURE is a block diagram of a projector in accordance with an embodiment.

Corresponding reference characters indicate corresponding parts. The exemplifications set out herein illustrate at least one preferred embodiment of the present a projector, in one form, and such exemplifications are not to be construed as limiting the scope of the invention in any manner.

### DETAILED DESCRIPTION OF THE EMBODIMENT

Referring to FIGURE, a projector 100 in accordance with an embodiment of the disclosure includes a projection lens 10 and an autofocus device. The projection lens 10 protrudes from an opening formed on front of a case (not shown) when a lens cover is opened. An image is projected onto a projection surface 70 through the projection lens 10. The projection surface 70 may be a screen, a whiteboard or a wall. The autofocus device includes an image capture device 30, a motor 40, an image analyzing device 50, and a focus controlling device 60.

The projection lens 10 is moved by the motor 40 to a plurality of positions along the optical axis. The focus controlling device 60 is configured to control the motor 40. The motor 40 is selected from the group consisting of a voice coil motor, an ultrasonic motor, a piezoelectric motor and a step motor.

The image capture device 30 is a charge coupled device configured to obtain image signals on the projection surface 70 from every position of the projection lens 10. The image capture device 30 may be a complementary metal oxide semiconductor.

The image analyzing device 50 connected to the image capture device 30 is configured to receive and analyzes the image signals captured by the image capture device 30. The image analyzing device 50 is configured for analyzing intensity difference between adjacent pixels of the images captured by the image capture device 30 and generating a control signal associated therewith.

The focus controlling device 60 is connected to the motor 40 and the image analyzing device 50. The focus controlling device 60 is configured for focusing the projection lens 10 at a position where there is maximum intensity difference between adjacent pixels in response to the control signal from the image analyzing device 50.

Time previously spent manually adjusting the projector is conserved such that efficiency of the projector is improved.

It is to be understood that the disclosure is intended to illustrate rather than limit the invention. Variations may be made to the embodiment without departing from the spirit of the invention as claimed. The above-described embodiment illustrates the scope of the invention but do not restrict the scope of the invention.

What is claimed is:

1. A projector, comprising:
a projection lens for projecting an image onto a projection surface;
an image capture device for capturing images of the image projected on the projection surface;
an image analyzing device for analyzing intensity difference between adjacent pixels of the images captured by the image capture device and generating a control signal associated therewith; and
a focus controlling device for focusing the projection lens at a position where there is maximum intensity difference between adjacent pixels in response to the control signal from the image analyzing device.

2. The projector as claimed in claim 1, wherein the motor is selected from the group consisting of a voice coil motor, an ultrasonic motor, a piezoelectric motor and a step motor.

3. The projector as claimed in claim 1, wherein the image capture device is a charge coupled device or a complementary metal oxide semiconductor.
